(19) United States
(12) Patent Application Publication
(10) Pub. No.: US 2007/0076230 A1
(43) Pub. Date: Apr. 5, 2007

(54) DUAL-DESKTOP REMOTE CONTROL SYSTEM AND METHOD

(75) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,372

(22) Filed: Aug. 2, 2006

(30) Foreign Application Priority Data
Sep. 9, 2005 (CN) 200510037228.9

(51) Int. Cl. G06F 3/12

(52) U.S. Cl. 358/1.2; 358/1.15

(57) ABSTRACT

A dual-desktop remote control system is provided. The remote control system includes: a connection module for connecting a local computer to a remote computer, wherein the local computer is a default master computer, and the remote computer is a default secondary computer; an image extracting module for extracting an image of an output display of the default secondary computer as a extracted image; an image resizing module for resizing the extracted image from the default secondary computer into a resized image; and an image superimposing module for superimposing the resized image upon an image of an output display of the default master computer. Another corresponding method is also provided.

### TECHNICAL FIELD

The present invention relates generally to remote control systems and methods, and particularly to a dual-desktop remote control system and method.

### GENERAL BACKGROUND

Since the mide-1990s, internet based conferencing systems have been used by companies to improve customer service on their websites. By implementing this live support functionality, these companies have realized significant increase in sales and decrease in customer support costs. These prior art conferencing systems realize a demonstrational support for a remote user located at a remote computer by a local computer.

In addition, a network administrator in a company often needs to enter to a remote control mode, in order to control one or more remote computers.

The above-described technologies transmit desktop information of the local computer to the remote computers, and can also control the remote computers by the local computer. However, an image of an output display of the remote computer is displayed on the image of an output display of the local computer. After a local user opens a file on the local computer, the file overlays the image of the output display of the remote computer, this is not convenient for the local user to view the images of the output display coming from the remote computer.

Accordingly, what is needed is a dual-desktop remote control system and method which can overcome the above-described problem.

### SUMMARY

A dual-desktop remote control system is provided. The remote control system includes: a connection module for connecting a local computer to a remote computer, wherein the local computer is set to default as a master computer, and the remote computer is set to default as a secondary computer; an image extracting module for extracting an image of an output display of the secondary computer as an extracted image; an image resizing module for resizing the extracted image from the secondary computer into a resized image; and an image superimposing module for superimposing the resized image upon an image of an output display of the default master computer.

A dual-desktop remote control method is also provided. The method includes the steps of: (a) connecting a local computer to a remote computer, wherein the local computer is set to default as a master computer, and the remote computer is set to default as a secondary computer; (b) extracting an image of an output display of the secondary computer as an extracted image; (c) resizing the extracted image from the secondary computer into a resized image; and (d) superimposing the resized image upon an image of a output display of the master computer.

In addition, a computer enabling dual-desktop remote control is provide. The computer includes a connection module for connecting the computer to a remote computer, wherein the computer is set to default as a master computer, and the remote computer is set to default as a secondary computer; an image extracting module for extracting an image of an output display of the secondary computer as an extracted image; an image resizing module for resizing the extracted image from the secondary computer into a resized image; and an image superimposing module for superimposing the resized image upon an image of a desktop of the master computer.

Other advantages and novel features will become more apparent from the following detailed description when taken in conjunction with the accompanying drawings, in which:

### BRIEF DESCRIPTION OF DRAWINGS

FIG. 1 is an application circumstance diagram of a dual-desktop remote control system in accordance with a preferred embodiment of the present invention;

FIG. 2 is a schematic diagram of main function modules of the system of FIG. 1;

FIG. 3 is a schematic diagram showing dual-desktop display of the dual-desktop remote control system of FIG. 1;

FIG. 4 is a flowchart of a preferred dual-desktop remote control method performed by implementing the system of FIG. 1; and

FIG. 5 is a flowchart of one step of the dual-desktop remote control method of FIG. 4, namely performing operations on the current master computer.

### DETAILED DESCRIPTION OF THE PREFERRED EMBODIMENT

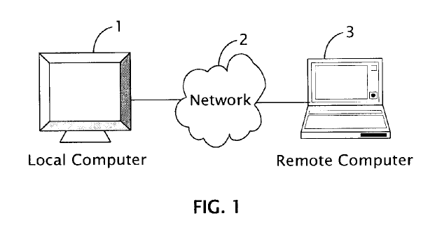

FIG. 1 is an application circumstance diagram of a dual-desktop remote control system (hereafter, “the system,”) in accordance with a preferred embodiment of the present invention. The system can be implemented with a local computer 1 and one or more remote computers 3. The local computer 1 is connected to the remote computer 3 through a network 2. The network 2 may be an Intranet, the Internet or the like.

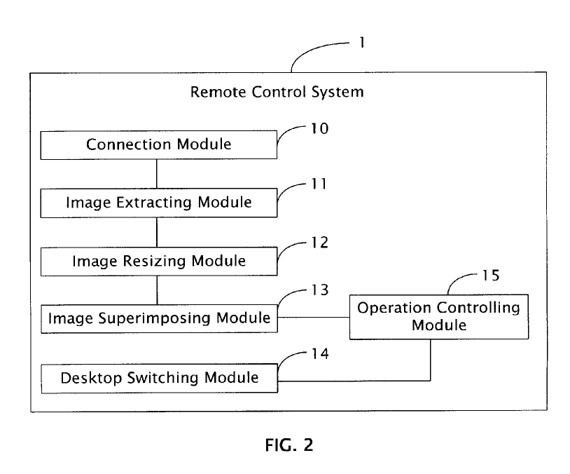

FIG. 2 is a schematic diagram of main function modules of the system of FIG. 1. In the preferred embodiment, the system includes a connection module 10, an image extracting module 11, an image resizing module 12, an image superimposing module 13, a desktop switching module 14, and an operation controlling module 15.

The connection module 10 connects the local computer 1 to the remote computer 3. In an initial state, the local computer 1 is a default master computer, the remote computer 3 is a default secondary computer. The image extracting module 11 extracts an image of an output display of the default secondary computer as an extracted image. The image resizing module 12 resizes the extracted image from the default secondary computer into a resized image. The image superimposing module 13 superimposes the resized image from the default secondary computer upon an image of an output display of the default master computer. The desktop switching module 14 is used for switching the default secondary computer as a master computer when the resized image of the default secondary computer is clicked. The operation controlling module 15 performs a corresponding control in response to an operation on the master computer. For example, if a current master computer is the local computer 1, the operation controlling module 15 performs the operation on the local computer; if the current master computer is the remote computer 3, the operation controlling module 15 generates an instruction set to initiate the remote computer 3 to perform the operation.

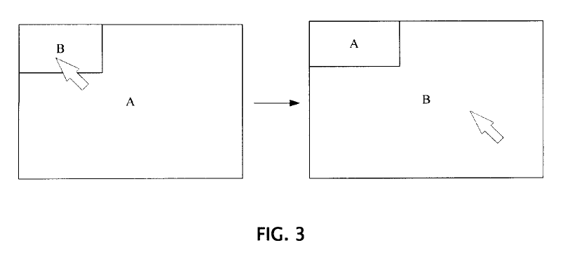

FIG. 3 is a schematic diagram showing dual-desktop display of the dual-desktop remote control system of FIG. 1. In an initial state, the local computer (labeled A) is the default master computer, and the remote computer (labeled B) is the default secondary computer. When the resized image of the default secondary computer (i.e., the remote computer B) is clicked, the desktop switching module 14 switches the default secondary computer (i.e., the remote computer B) as the master computer, and concurrently, switches the default master computer (i.e., the local computer A) as the secondary computer.

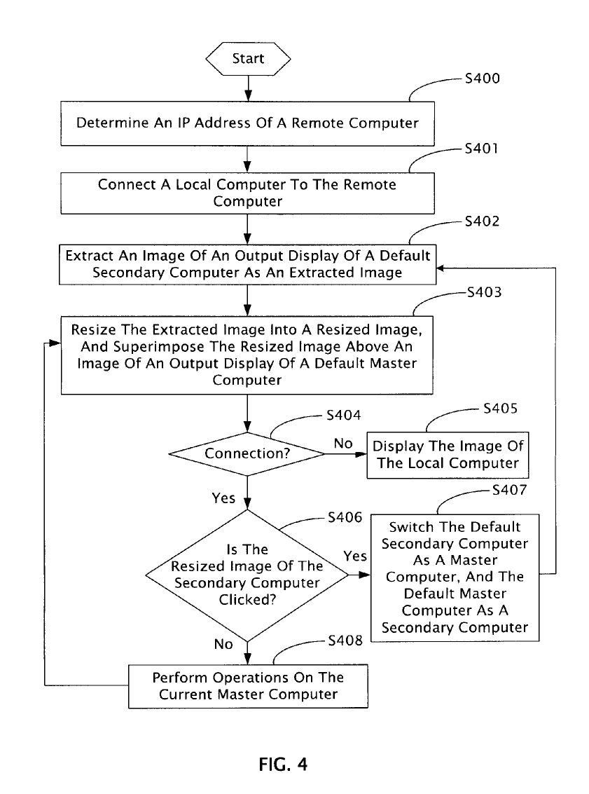

FIG. 4 is a flowchart of a preferred dual-desktop remote control method performed by implementing the system of FIG. 1. In step S400, the local computer 1 determines an Internet Protocol (IP) address of the remote computer 3. In step S401, the connection module 10 connects the local computer 1 to the remote computer 3 according to the IP address. The local computer 1 is the default master computer, and the remote computer 3 is the default secondary computer. In step S402, the image extracting module 11 extracts the image of the output display of the default secondary computer (i.e., the remote computer 3) as an extracted image. In step S403, the image resizing module 12 resizes the extracted image from the default secondary computer (i.e., the remote computer 3) into a resized image, and the image superimposing module 13 superimposes the resized image upon the image of the output display of the default master computer (i.e., the local computer 1). In step S404, the local computer 1 determines whether it receives an operation to close the connection to the remote computer 3. If so, in step S405, the local computer 1 disables the connection to the remote computer 3 and displays the image of output display of the local computer 1. Otherwise, in step S406, the operation controlling module 105 determines whether the resized image of the default secondary computer (i.e., the remoter computer 3) is clicked. If the resized image of the default secondary computer is clicked, in step S407, the desktop switching module 14 switches the default secondary computer as a master computer, and the default master computer as a secondary computer, whereupon the procedure returns to step S402 described above. Otherwise, in step S408, the operation controlling module 15 performs operations on the current master computer, whereupon the procedure returns to step S403 described above.

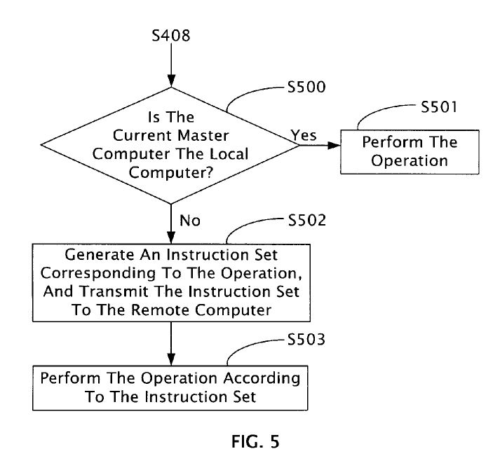

FIG. 5 is flowchart of step S408 of the dual-desktop remote control method of FIG. 4, namely performing operations on the current master computer. In step S500, the system determines whether the current master computer is the local computer 1. If the master computer is the local computer 1, in step S501, the operation controlling module 105 performs the operation locally thereon. If the current master computer is the remote computer 3, in step S502, the operation controlling module 105 generates the instruction set corresponding to the operation, and transmits the instruction set to the remote computer 3. In step S503, the remote computer 3 initiates to perform the operation according to the instruction set.

Although the present invention has been specifically described on the basis of the preferred embodiment including the preferred method, the invention is not to be construed as being limited thereto. Various changes or modifications may be made to the embodiment including the method without departing from the scope and spirit of the invention.

What is claimed is:

1. A dual-desktop remote control system comprising:
a connection module for connecting a local computer to a remote computer, wherein the local computer is set to default as a master computer, and the remote computer is set to default as a secondary computer;
an image extracting module for extracting an image of an output display of the secondary computer as an extracted image;
an image resizing module for resizing the extracted image from the secondary computer into a resized image; and
an image superimposing module for superimposing the resized image upon an image of an output display of the default master computer.

2. The dual-desktop remote control system according to claim 1, further comprising a desktop switching module for switching the secondary computer as the master computer when the resized image of the default secondary computer is clicked.

3. The dual-desktop remote control system according to claim 2, further comprising an operation controlling module for performing a corresponding control in response to an operation on the master computer.

4. The dual-desktop remote control system according to claim 3, wherein the operation controlling module performs the operation on the local computer if the master computer is the local computer, or generates an instruction set to initialize the remote computer to perform the operation if the master computer is the remote computer.

5. A dual-desktop remote control method comprising the steps of:
connecting a local computer to a remote computer, wherein the local computer is set to default as a master computer, and the remote computer is set to default as a secondary computer;
extracting an image of an output display of the secondary computer as an extracted image;
resizing the extracted image from the secondary computer into a resized image; and
superimposing the resized image upon an image of a output display of the master computer.

6. The dual-desktop remote control method according to claim 5, further comprising the step of switching the secondary computer as the master computer when the resized image of the secondary computer is clicked.

7. The dual-desktop remote control method according to claim 5, further comprising the step of performing a corresponding control in response to an operation on the master computer.

8. The dual-desktop remote control method according to claim 7, wherein the performing step further comprises the steps of:
determining whether the master computer is the local computer;
performing the operation on the local computer if the current computer is the local computer;
generating an instruction set to initialize the remote computer to perform the operation if the master computer is the remote computer; and
performing the instruction on the remote computer.

9. A computer enabling dual-desktop remote control, the computer comprising:
a connection module for connecting the computer to a remote computer, wherein the computer is set to default as a master computer, and the remote computer is set to default as a secondary computer;
an image extracting module for extracting an image of an output display of the secondary computer as an extracted image;
an image resizing module for resizing the extracted image from the secondary computer into a resized image; and
an image superimposing module for superimposing the resized image upon an image of a desktop of the master computer.

10. The computer according to claim 9, further comprising a desktop switching module for switching the secondary computer as the master computer when the resized image of the secondary computer is clicked.

11. The computer according to claim 9, further comprising an operation controlling module for performing a corresponding control in response to an operation on the master computer.

12. The computer according to claim 11, wherein the operation controlling module performs the operation on the local computer if the master computer is the local computer, generates an instruction set to initialize the remote computer to perform the operation if the master computer is the remote computer.
